(19) United States
(12) Patent Application Publication
(10) Pub. No.: US 2004/0077446 A1
(43) Pub. Date: Apr. 22, 2004

(54) Belt tensioner assembly for internal combustion engine

(75) Inventor: Eric Keith Manning, Toledo, OH (US)

Correspondence Address: Liniak, Berenato & White, Ste. 240, 6550 Rock Spring Drive, Bethesda, MD, 20817, US

(73) Assignee: DANA CORPORATION

(21) Appl. No.: 10/277,254

(22) Filed: Oct. 22, 2002

(51) Int. Cl. F16H 7/12

(52) U.S. Cl. 474/134; 474/117; 474/135

(57) ABSTRACT

A belt tensioner assembly for an internal combustion engine. A pair of tension members such as rollers engages the belt on opposite sides of a driving/driven member, such as a starter/alternator. The tension members are movably secured to the engine block or other device and are spring biased to engage the belt. Engaging the belt at multiple points and on either side of a driving/driven member, a floating tensioning device is created thus facilitating the ability to maintain sufficient minimum tension in the belt to prevent slippage regardless of load conditions.

### BACKGROUND OF THE INVENTION

1. Field of the Invention

The present invention is directed to a belt tensioner assembly for an internal combustion engine.

2. Description of the Related Art

Belt tensioners are well known in the prior art and have been used in many belt systems for some time. A belt tensioner is often a movable support structure that rotatably supports a portion of a belt in an engine or other mechanical system. The belt tensioner is movable to compensate for increases or decreases in belt path length due to wear and other factors to provide a constant belt tensioning force on a timing or drive belt.

A common type of conventional belt tensioner includes a fixed structure and a pivoted structure pivotally mounted on the fixed structure by a pivot assembly. The pivoted structure carries a belt-engaging pulley. A coil spring is mounted in surrounding relation to the pivot assembly and the ends of the spring are connected between the fixed and pivoted structures to bias the latter with respect to the former toward a position of maximum belt take-up. The spring biasing force decreases as the pivoted structure moves from a position of minimum belt take-up to a position of maximum belt take-up in an effort to maintain tension on the belt. Often the tensioner is installed to apply a predetermined static tensioning force on one side of the belt. On some belt tensioners, this is achieved by adjusting the tensioner so that the pivoted structure that carries the pulley is positioned between two end stops that define the range of movement for the pivoted structure. A belt tensioner should maintain the proper belt tension level throughout the entire operational angular movement of the pivoted structure.

It is conventional to place a belt tensioner in a drive system that includes a belt for transmitting motion from a driving pulley to one or more driven pulleys. Such a tensioner generally comprises a device of the piston-and-cylinder type for guiding relative translation between first and second assemblies, the first assembly being secured to a first end of the tensioner and fixed directly or indirectly to the engine block, while the second assembly is secured to a second end of the tensioner and carries a wheel that runs on the belt, the two assemblies being surrounded by a helical return spring urging said assemblies towards a spaced-apart position. Improved tensioners of known types also include hydraulic damping means. Although such tensioners generally give satisfaction, they are relatively expensive. In addition, some embodiments are bulky and/or of limited lifetime. Furthermore, because it has a return spring that is radially on the outside, a conventional type of tensioner has to be fixed via one of its ends. Such fixing is not necessarily the strongest nor the best suited to the small amount of space available in an engine compartment.

However, the belt tensioners of the prior art apply tension to a single point along the belt. Such prior art assemblies also fail to account for torque applied to the belt in opposite directions such as when incorporating a starter/alternator assembly even though the belt runs only in a single direction.

### SUMMARY OF THE INVENTION

The present invention is directed to a belt tensioner assembly for an internal combustion engine. A pair of tension members such as rollers, engage the belt on opposite sides of a driving/driven member, such as a starter/alternator. The tension members are movably secured to the engine block or other device and are spring biased to engage the belt. Engaging the belt at multiple points and on either side of a driving/driven member, a floating tensioning device is created thus facilitating the ability to maintain substantially constant tension on the belt regardless of load conditions.

### BRIEF DESCRIPTION OF THE DRAWINGS

FIGS. 1a-1c represents a schematic view of a belt tensioner assembly employed in an internal combustion engine in various modes of operation.

FIG. 2 is an isolated schematic view of the belt tensioner assembly of FIG. 1 according to the present invention.

FIG. 3 is an isolated schematic view of the belt tensioner assembly according to an alternate embodiment of the present invention.

FIG. 4 is an isolated schematic view of the belt tensioner assembly according to an alternate embodiment of the present invention.

FIG. 5 is an isolated schematic view of the belt tensioner assembly according to an alternate embodiment of the present invention.

FIG. 6 is an isolated schematic view of the belt tensioner assembly according to an alternate embodiment of the present invention.

FIG. 7 is an isolated schematic view of the belt tensioner assembly according to an alternate embodiment of the present invention.

FIG. 8 is an isolated schematic view of the belt tensioner assembly according to an alternate embodiment of the present invention.

FIG. 9 is an isolated schematic view of the belt tensioner assembly according to an alternate embodiment of the present invention.

FIG. 10 is an isolated schematic view of the belt tensioner assembly according to an alternate embodiment of the present invention.

FIG. 11 is an isolated schematic view of the belt tensioner assembly according to an alternate embodiment of the present invention.

FIG. 12 is an isolated schematic view of the belt tensioner assembly according to an alternate embodiment of the present invention.

FIG. 13 is an isolated schematic view of the belt tensioner assembly according to an alternate embodiment of the present invention.

FIG. 14 is an isolated schematic view of the belt tensioner assembly according to an alternate embodiment of the present invention.

FIG. 15 is an isolated schematic view of the belt tensioner assembly according to an alternate embodiment of the present invention.

FIG. 16 is an isolated schematic view of the belt tensioner assembly according to an alternate embodiment of the present invention.

FIG. 17 is an isolated schematic view of the belt tensioner assembly according to an alternate embodiment of the present invention.

FIG. 18 is an isolated schematic view of the belt tensioner assembly according to an alternate embodiment of the present invention.

FIG. 19 is an isolated schematic view of the belt tensioner assembly according to an alternate embodiment of the present invention.

FIG. 20 is an isolated schematic view of the belt tensioner assembly according to an alternate embodiment of the present invention.

FIG. 21 is an isolated schematic view of the belt tensioner assembly according to an alternate embodiment of the present invention.

FIG. 22 is an isolated schematic view of the belt tensioner assembly according to an alternate embodiment of the present invention.

FIG. 23 is an isolated schematic view of the belt tensioner assembly according to an alternate embodiment of the present invention.

FIG. 24 is an isolated schematic view of the belt tensioner assembly according to an alternate embodiment of the present invention.

FIG. 25 is an isolated schematic view of the belt tensioner assembly according to an alternate embodiment of the present invention.

FIG. 26 is an isolated schematic view of the belt tensioner assembly according to an alternate embodiment of the present invention.

FIG. 27 is an isolated schematic view of the belt tensioner assembly according to an alternate embodiment of the present invention.

FIG. 28 is a partial perspective view of a workable tensioner assembly according to the invention of FIGS. 1A-1C.

### DESCRIPTION OF THE PREFERRED EMBODIMENTS

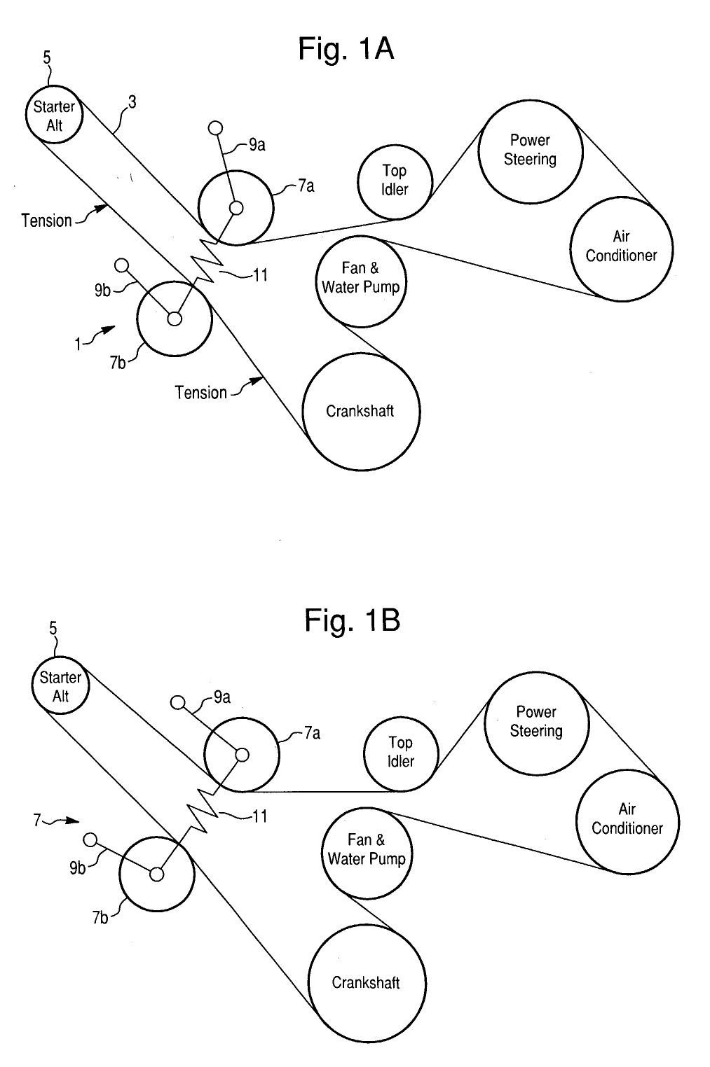

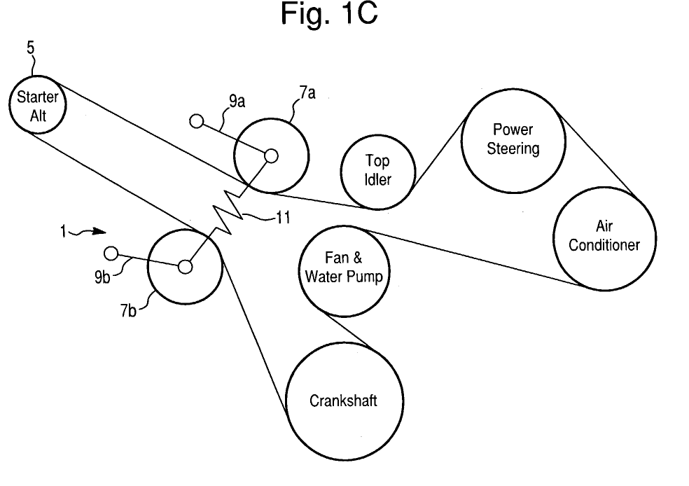

FIGS. 1A-1C depict schematic views of a belt tensioner assembly 1 employed in an internal combustion engine. The belt 3 is wrapped in a serpentine fashion about the engine crankshaft and accessory devices such as the fan/water pump, power steering, air conditioner, and a starter/alternator assembly 5. Each of the accessories, idler and crankshaft has an associated pulley to engage the belt as is well known in the art. To maintain proper minimum tension in the belt 3, a pair of rollers 7a, 7b are biased to engage the belt 3 on opposite sides of the starter/alternator 5. The rollers 7a, 7b are rotatably mounted to a corresponding pivot arm 9a, 9b which are in turn pivotally mounted relative to the internal combustion engine in a plain parallel to the pulleys of the starter/alternator and other accessories. A spring 11 connects the pivot arms 9a, 9b adjacent the connection with the rollers 7a, 7b and biases the rollers 7a, 7b into engagement with the belt 3. It is to be understood the specific structure of the rollers and pivot arms are not essential to the present invention and one of ordinary skill in the art can fashion a suitable pivot arm, such as one made of steel or other strong metal allow or other material sufficient to rotatably support a roller. The pivot arms may be directly mounted to the engine block or other bracket device easily fashioned by one of ordinary skill in the art. Therefore the present invention is represented in schematic form to depict the kinematic relationship rollers and associated pivot arms in relation to the driven belt 3. The resultant tensioner assembly forms a free-floating tension assembly providing the ability to maintain a substantially constant tension in the belt irrespective of modes of operation of the starter/alternator.

In conventional simple belt-driven systems having at least two pulleys, the transfer of torque from one pulley to the second pulley is created by tension and contact friction in the section of the belt transmitting the torque and slack (non tension) in the opposite side of the belt. The slack section versus tension section of the belt is determined by the location of the driven pulley and the direction of rotation. In a typical automobile belt driven accessory system, the multiple pulley system rotates in one direction and has only one drive pulley, the crankshaft. Since a typical automobile belt system rotates in one direction and has only one drive pulley, the tension section of the belt remains in one area of operation of the belt. The change in the amount of tension in the belt section is created by the change in torque demand of the various accessories and engine speed. A single pivot arm tensioner is added on the slack section of the typical automobile belt system to maintain a minimum belt tension for the changes in torque demand.

However, starter/alternators, unlike other engine accessories, operates in different modes and applies torque to the belt in opposite directions depending on the mode of operation. In these new systems, a belt driven starter/alternator introduces a second drive pulley that can provide torque to start the engine during the starting process. The belt driven starter/alternator changes the section of the belt that is the tension section when the crankshaft is driven to start the engine. After the engine is started, the belt-driven starter/alternator changes to generation mode and the belt tension changes to another section of the belt (adjacent the crankshaft.) Thus belt tensioners of the prior art can not accommodate a change in location of the tension section in addition to changes in accessory torque load demand and provide load to the belt to maintain minimum tension in the belt to prevent slippage.

As previously discussed, when in a starting mode, the starter/alternator drives the belt in order to drive the crankshaft to initiate ignition. During the start mode torque is thus applied to the belt in same direction as the belt is driven. Once the engine starts the start mode is discontinued and the starter/alternator may briefly enter a no load stage where no torque is applied to the belt and the pulley associated with the starter/alternator is essentially allowed to spin freely. However, after the engine is running, the starter/alternator operates in a generation mode to provide an electrical source to run the electrical system of the engine. In the generation mode, the starter/alternator is being driven by the belt 3 and thus applies torque to the belt in a direction opposite to that of belt travel and opposite to the direction of torque applied during start mode. The free floating tensioner assembly of the present invention accommodates these different modes of operation to maintain minimum tension in the belt irrespective of torque load demand or mode of operation.

The tensioner assembly of the present invention responds to different load conditions and modes of operation at any given instant in time. The tensioner assembly applies a load that will be distributed equally between the two sections of the belt 7a, 7b that the tensioner is in contact with the belt. The amount of load applied by the tensioner assembly depends on the distance between the rollers 7a, 7b, the relative position of the rollers 7a, 7b etc. as dictated by load conditions of the engine assembly.

FIG. 1b represents a state where the starter/alternator is in an off mode (i.e. the belt is not moving or the associate pulley allowed to spin freely. Both these sections of the belts (7a, 7b) appear to be on the slack side and thus both sections will deflect according as dictated by the kinematic relationship between the pivot arms 9a, 9b and spring 11. FIG. 1 a represents the system in a start mode where the starter/alternator 5 drives the belt and applies a load on the belt in the same direction as the belt travel and thus the tension side of the starter/alternator exists on the side of roller 7b. The tensioner assembly will automatically react such that the tension side of the belt will have minimal deflection and the slack side of the belt will have a much larger deflection. Note pivot arm 9b deflects less relative to position shown in FIG. 1b than the more exaggerated deflected pivot arm 9a. The amount of deflection on the tension side of the belt will depend on the amount of tension in that side of the belt by the torque being transmitted and the load exerted by the spring. The spring 11, or springs, between the pivot arms 9a, 9b will provide sufficient load to maintain a minimum tension in the system and will provide additional load as the distance between the tensioner arms increases which is necessary as the tensioner arms pivot through their range of motion.

FIG. 1c represent another mode of operation where the starter/alternator is in a generation mode. In this environment, the starter/alternator places a load demand on the belt much like the other accessories. The crankshaft now drives the belt and thus the section of the belt in tension, tension side of the belt, moves relative to the starter/alternator 5 as indicated in FIG. 1c. Thus as can be seen in FIG. 1c, pivot arm 9b deflects more greatly than pivot arm 9a relative to the free state as shown in FIG. 1b. Thus the tensioner assembly of the present invention forms a floating tensioner assembly that automatically shifts to apply tension in the belt during different modes of operation and torque load demand.

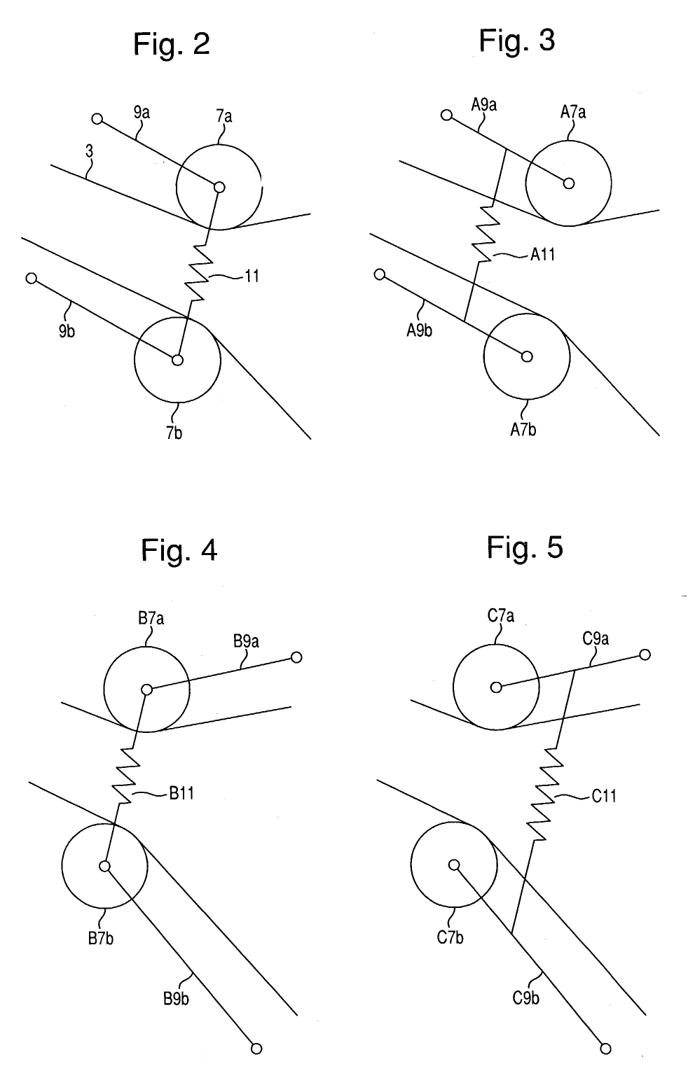

FIG. 2 represents an isolated schematic view of the tensioner assembly of FIGS. 1A-1C. No additional explanation of the components is necessary. FIGS. 3-27 represent various alternate embodiments of the present invention which operate in a similar manner by providing a floating tensioner assembly to engage different sections of the belt to accommodate different modes of operation and torque load demands. The structure of the embodiments will be discussed below in a no load state. However, the operation remains principally the same as the embodiment of FIGS. 1A-1C. The relation to the starter/alternator and remaining components of the internal combustion engine are the same as depicted in FIGS. 1A-1C.

FIG. 3 represents an alternate embodiment of the present invention. Similar to the arrangement of FIG. 2, the spring A-11 is connected to intermediate portions of pivot arms A9a, A9b.

In FIG. 4 the pivot arms B9a, B9b substantially in a mirror extend in the opposite direction from that of shown in FIG. 2 and are anchored about a pivot point of greater distance than pivots arms 9a, 9b.

FIG. 5 represents an alternate embodiment of the present invention. This embodiment is similar to that of FIG. 4 with the spring C11 connected to intermediate portions of pivot arms C9a, C9b.

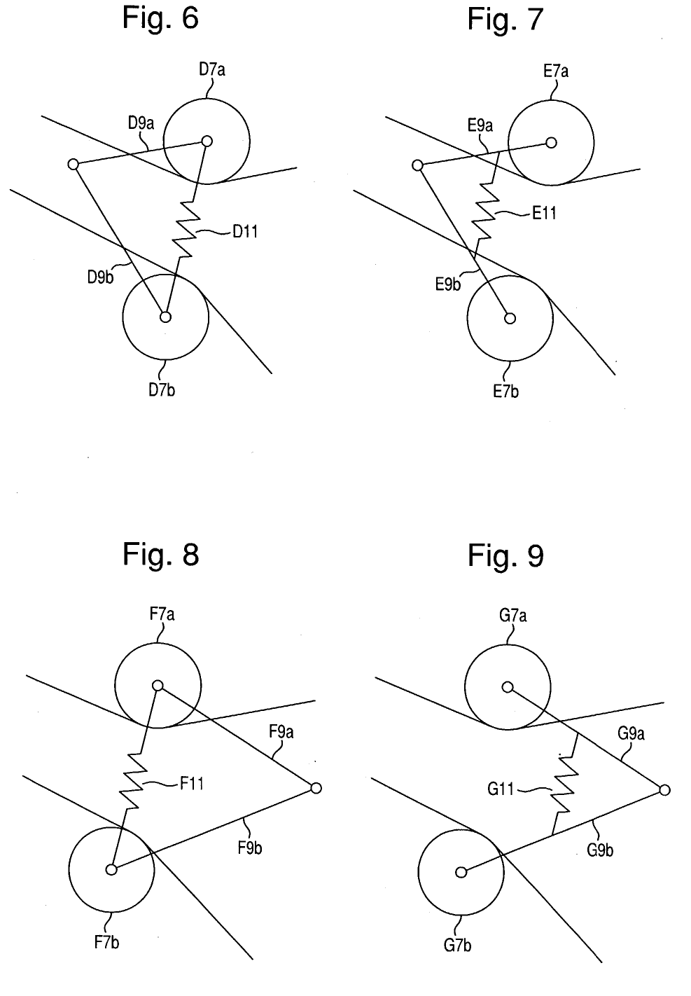

FIG. 6 represents an alternate embodiment of the present invention. The pivot arms D9a, D9b pivot about a common point intermediate the rollers D7a, D7b.

FIG. 7 represents an alternate embodiment of the present invention similar to that of FIG. 6. However, the spring E11 connects to the pivot arms E9a, E9b at an intermediate portion thereof.

FIG. 8 represents an alternate embodiment of the present invention similar to that of FIG. 6. However the pivot arms F9a, F9b extend in the opposite direction and relative to the starter/alternator.

FIG. 9 represents an alternate embodiment of the present invention similar to that of FIG. 8. However, the spring G11 connects to the pivot arms G9a, G9b at an intermediate portion thereof.

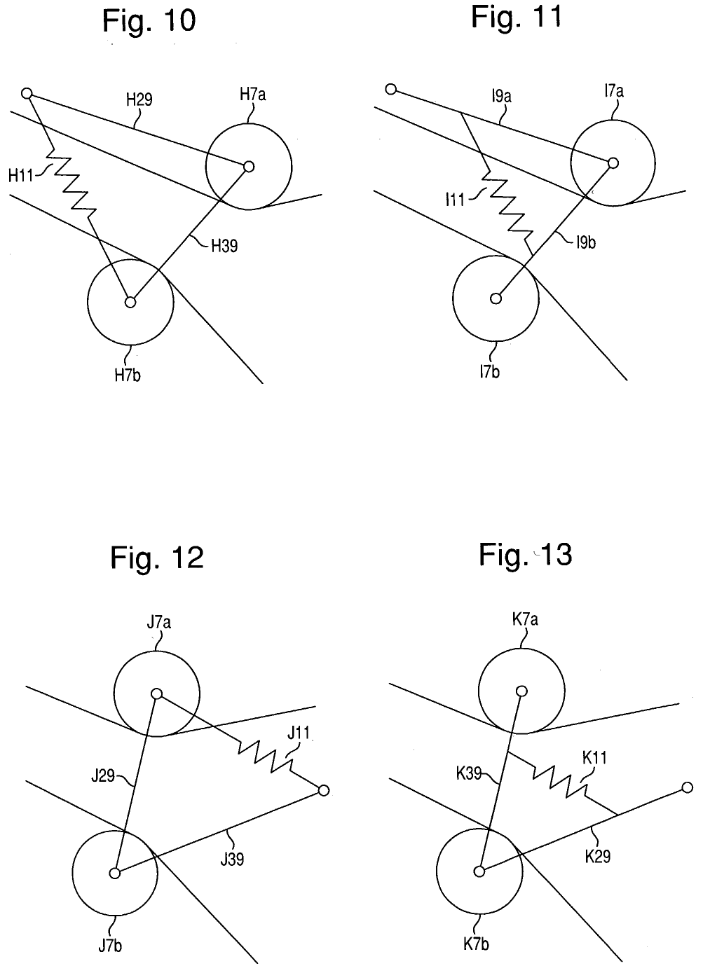

FIG. 10 represents an alternate embodiment of the present invention. Pivot arm H39 interconnects rollers H7a, H7b. Roller H7a is connected to a pivot art H29. Pivot arm H29 and H39 are connected by spring H11 at end portions thereof.

FIG. 11 represents an alternate embodiment of the present invention similar to that of FIG. 10. However, the spring 11 connects to the pivot arms 19a, 19b at an intermediate portion thereof.

FIG. 12 represents an alternate embodiment of the present invention similar to that of FIG. 10 with the pivots arms J29, J39 and spring J11 arranged in a mirror image to that of FIG. 10.

FIG. 13 represents an alternate embodiment of the present invention similar to that of FIG. 12. However, the spring I11 connects to the pivot arms I9a, I9b at an intermediate portion thereof.

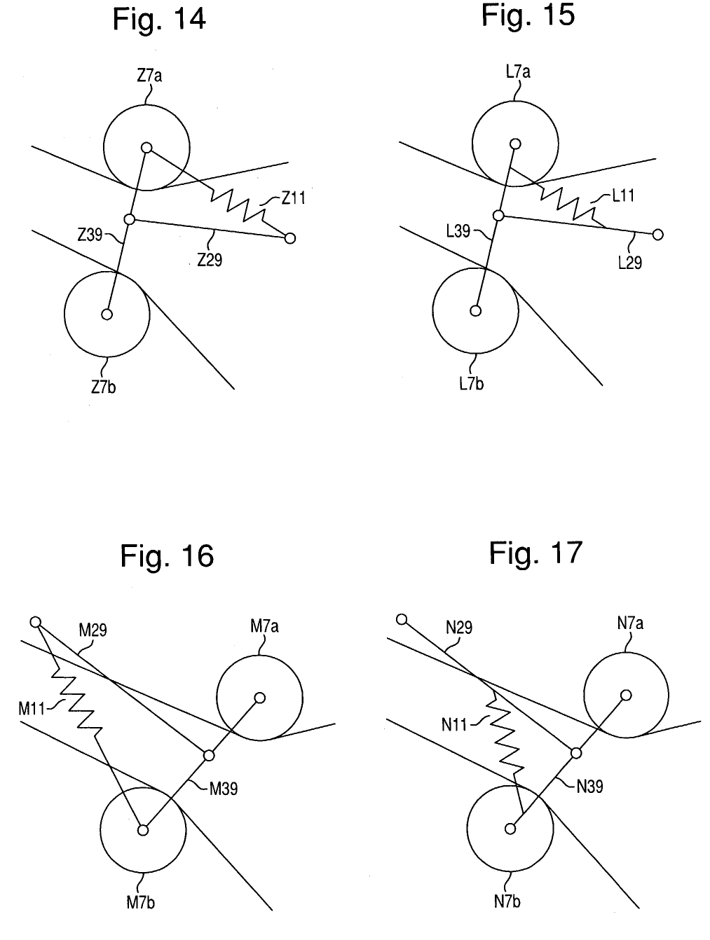

FIG. 14 represents an alternate embodiment of the present invention. Pivot arm Z39 interconnects rollers Z7a, Z7b. A second pivot arm Z29 is pivotally connected relative to the engine and is rotatably connected to an intermediate portion of pivot arm Z39. A spring Z11 interconnects pivot arm Z29 with pivot arm Z39 adjacent roller Z7a. The rollers Z7a, Z7b may rotate about the interconnection of pivot arms Z39, Z29 and may rotate together with pivot arm Z30 about the end of pivot arm Z29.

FIG. 15 represents an alternate embodiment of the present invention similar to that of FIG. 14. However, the spring L11 connects to the pivot arms L9a, L9b at an intermediate portion thereof.

FIG. 16 represents an alternate embodiment of the present invention similar to that of FIG. 14 with the pivots arm M29 and spring M11 arranged in a mirror image relative to the starter/alternator than that of the embodiment of FIG. 10.

FIG. 17 represents an alternate embodiment of the present invention similar to that of FIG. 16. However, the spring N11 connects to the pivot arms N29, N39 at an intermediate portion thereof.

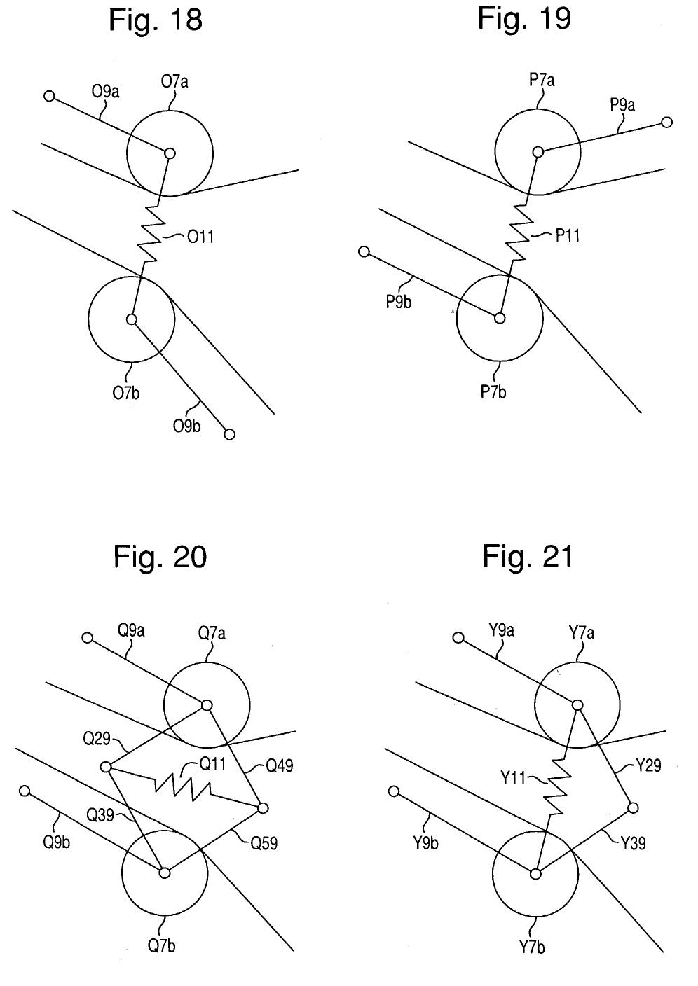

FIG. 18 represents an alternate embodiment of the present invention similar to that of FIG. 2. However, pivot arm O9b extends substantially in an opposite direction than 7b.

FIG. 19 represents an alternate embodiment of the present invention similar to that of FIG. 2. However, pivot arm O9a extends substantially in an opposite direction than 7a.

FIG. 20 represents an alternate embodiment of the present invention. Relative to the embodiment of FIG. 2, spring 11 is replaced by a parallelogram of four pivotally connected pivot arms Q29, Q39, Q49 7 Q59. The kinematics of the parallelogram arrangement provides more precise and predictable displacement of the rollers. A compression spring Q11 forces the pivot arms Q2,/Q39 and Q49/Q59 outward to bias the rollers Q7a/Q7b into engagement with the belt.

FIG. 21 represents an alternate embodiment of the present invention. Relative to the embodiment of FIG. 2, spring 11 is supplemented with a pair of pivot arms Y29, Y39 pivotally connected to one another and extending between rollers Y7a, Y7b. Tension spring Y11 biases rollers Y7a/Y7b into engagement with the belt.

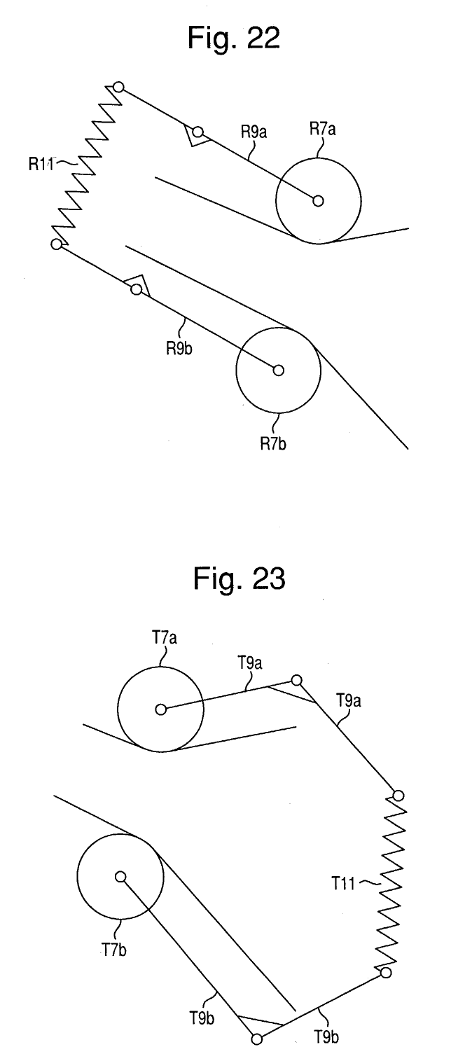

FIG. 22 represents an alternate embodiment of the present invention. Pivot arms R9a, R9b pivot about an intermediate point along a length thereof. Compression spring R11 urges the ends of pivot arms R9a, R9b apart to bias rollers R7a, R7b towards engagement with the belt.

FIG. 23 represents an alternate embodiment of the present invention. Pivot arms T9a, T9b pivot about an intermediate point along a length thereof much like the embodiment of FIG. 22. However, pivot arms T9a, T9b are not linear. Two linear portions of the pivot arms R7a, R7b are rigidly connected to one another at a juncture point and may be supported by a brace or other structural member. The non-linear pivot arms T7a, T7b rotate about their associated juncture points. Compression spring T11 urges the ends of pivot arms T9a, T9b apart to bias rollers T7a, T7b towards engagement with the belt.

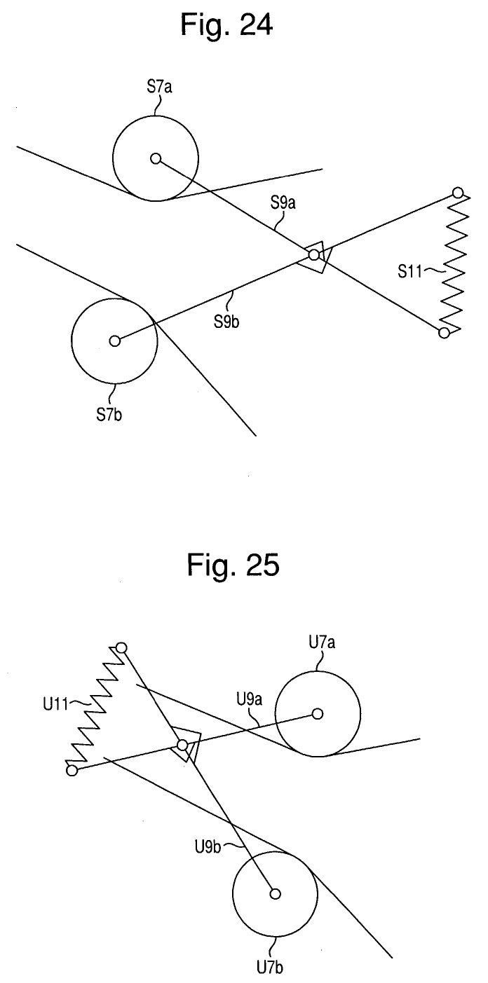

FIG. 24 represents an alternate embodiment of the present invention. Pivot arms S9a, S9b extend along a substantially linear path and intersect each another at a common rotation point in a criss-cross fashion. Each of the pivot arms S9a, S9b rotate about that common point. tension spring S11 biases opposite portions of the pivot arms S9a, S9b towards one another which in turn biases rollers S7a, S7b into engagement with the belt.

FIG. 25 represents an alternate embodiment of the present invention similar to that of FIG. 24 with the pivots arm U9a, U9b extending in the opposite direction substantially forming a Mirror image of the embodiment of FIG. 24 relative to the starterValternator.

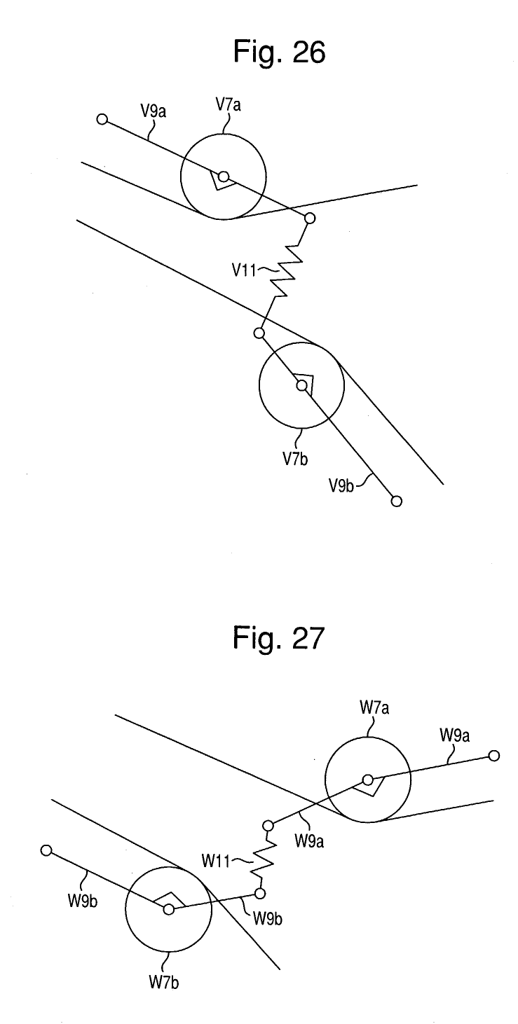

FIG. 26 represents and alternate embodiment of the present invention. The present embodiment is similar to that of FIG. 18 however the rollers V7a, V7b are mounted on an intermediate portion of the associated pivot arms V9a, V9b.

FIG. 27 represents and alternate embodiment of the present invention. The present embodiment is similar to that of FIG. 26 however the pivot arms W9a, W9b extend in reverse directions and are not linear. Rollers W7a, W7b are mounted to the pivot arms W9a, W9b at a juncture point between two linear portions forming the non-linear pivot arm.

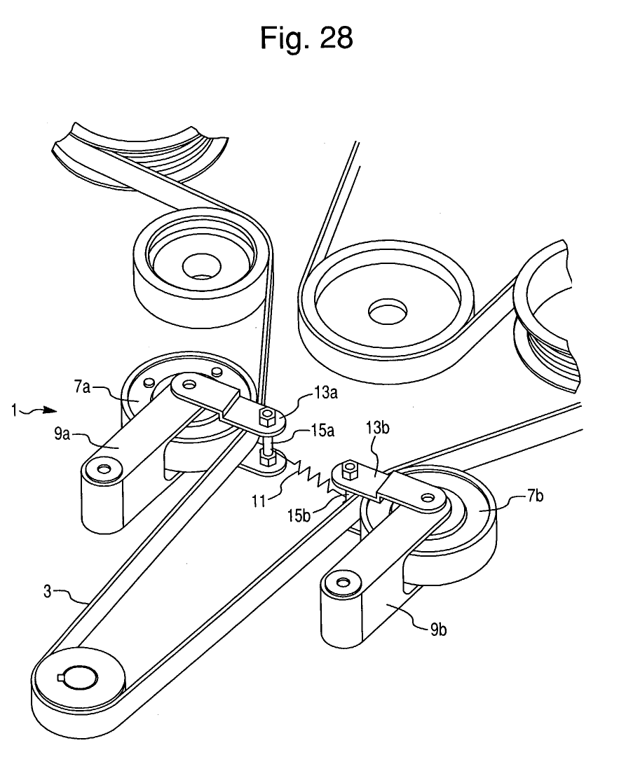

FIG. 28 depicts a partial perspective view of a working device according to the embodiment of FIGS. 1A-1C. Pivot arms 9a are rotatably connected relative to the internal combustion engine. The rollers 7a, 7b are simply rotatably connected to a corresponding pivot arm 9a, 9b. To facilitate connection of a spring device between pivot arms 9a, 9b, a pair of swing arms 13a, 13b are rotatably connected to an associated pivot arm 9a, 9b. Each swing arm is comprised of a pair of arms disposed on either side of the roller and pivot arm to prevent an unnecessary twisting load applied to the pivot arm. A pin 15a, 16b, is connected to the swing arm to facilitate connection to a spring schematically depicted as reference numeral 11. It is to be understood that the specific structure of the spring 11 is not essential to the present invention and may be in the form of many different spring devices, for example a helical tension spring. However, the present invention is not limited to a specific type of spring. Any biasing member that ensures that the rollers are biased towards engagement with the belt 3 may be employed.

While the foregoing invention has been shown and described with reference to a preferred embodiment, it will be understood by those possessing skill in the art that various changes and modifications may be made without departing from the spirit and scope of the invention. For example, several springs either in series or parallel may be substituted for the single spring 11 depicted in FIGS. 1A-1C. The spring may in the form of a tension spring, compression spring, or torsion spring. Other spring devices such as elastomeric materials, etc. or other devices may be employed so long as the rollers are continuously biased towards engagement with the belt. A damper may also be employed working in conjunction with the spring to provide a damping function. In the embodiments of FIGS. 6, 7, 9, 11, and 13, for example, a torsion spring may be employed at the pivoting intersection between the adjoining pivot arms. Stops or other limited devices may also be employed to limit the range of motion of the pivot arms. These and other modifications are believed to fall within the spirit of the present invention.

What is claimed is:

1. A belt tensioning arrangement in an internal combustion engine, said arrangement comprising:
a crank shaft having a first pulley;
at least one accessory device having a second pulley;
a belt at least partially wrapped around each said first and second pulleys to establish a driving connection there between; and
a tensioning device having at least two tension members engaging said belt on opposite sides of said second pulley along a travel path of said belt, said at least two tension members being movably mounted relative to said internal combustion engine and having a biasing member disposed to bias said tension members towards one another and into engagement with said belt to maintain sufficient minimum tension in said belt to prevent slippage.

2. The belt tensioning arrangement according to claim 1, wherein said tension members are formed as rollers rotatably connected to at least one pivot arm in turn pivotally mounted in a plane parallel to a plane of rotation of said second pulley.

3. The belt tensioning arrangement according to claim 2, wherein said bias member is a spring member connected to said at least one pivot arm to bias said rollers towards engagement with said belt.

4. The belt tensioning arrangement according to claim 3, wherein said spring member is directly connected to an intermediate portion of said at least one pivot arm.

5. The belt tensioning arrangement according to claim 1, wherein said at least two tension members comprise a pair of rollers one each secured to a corresponding one of a pair of pivot arms movably mounted in a plane parallel to a plane of rotation of said second pulley, said bias member comprising a spring member connecting said pair of pivot arms and in turn biasing said rollers toward engagement with said belt.

6. The belt tensioning arrangement according to claim 5, wherein said spring member is connected to an intermediate portion of one of said pivot arms.

7. The belt tensioning arrangement according to claim 1, wherein said at least two tension members comprise a pair of rollers disposed on opposite ends of a first pivot arm movably mounted in a plane parallel to a plane of rotation of said second pulley, a second pivot arm having a first end pivotally mounted about a first point within said plane of rotation and pivotally secured to said first pivot arm at a second point along an intermediate portion thereof such that said roller and said first pivot arm form a free floating assembly wherein said first pivot arm second pivot arm and said rollers may rotate about said first point and said first pivot arm and said rollers may independently rotate about said second point, and said bias member comprises a spring member connecting said first and second pivot arms to thereby bias said rollers towards engagement with said belt.

8. A belt tensioning arrangement in an internal combustion engine, said arrangement comprising:
a crank shaft having a first pulley;
at least one accessory device having a second pulley;
a belt at least partially wrapped around each said first and second pulleys to establish a driving connection there between; and
a tensioning device having at least two tension members engaging said belt on opposite sides of one said crank shaft and said at least one accessory along a travel path of said belt, said at least two tension members being movably mounted relative to said internal combustion engine and having a biasing member disposed to bias each of said tension members towards said belt, said movably mounted tensions members and said biasing member together forming a floating tension assembly to maintain proper minimum tension in said belt irrespective of torque load applied to said belt to thereby prevent said belt from slipping.

9. The belt tensioning arrangement according to claim 8, wherein said tension members are formed as rollers rotatably connected to at least one pivot arm in turn pivotally mounted in a plane parallel to a plane of rotation of said second pulley.

10. The belt tensioning arrangement according to claim 9, wherein said bias member is a spring member connected to said at least one pivot arm to bias said rollers towards engagement with said belt.

11. The belt tensioning arrangement according to claim 10, wherein said spring member is directly connected to an intermediate portion of said at least one pivot arm.

12. The belt tensioning arrangement according to claim 8, wherein said at least two tension members comprise a pair of rollers one each secured to a corresponding one of a pair of pivot arms movably mounted in a plane parallel to a plane of rotation of said second pulley, said bias member comprising a spring member connecting said pair of pivot arms and in turn biasing said rollers toward engagement with said belt.

13. The belt tensioning arrangement according to claim 12, wherein said spring member is connected to an intermediate portion of one of said pivot arms.

14. The belt tensioning arrangement according to claim 8, wherein said at least two tension members comprise a pair of rollers disposed on opposite ends of a first pivot arm movably mounted in a plane parallel to a plane of rotation of said second pulley, a second pivot arm having a first end pivotally mounted about a first point within said plane of rotation and pivotally secured to said first pivot arm at a second point along an intermediate portion thereof wherein said first pivot arm second pivot arm and said rollers may rotate about said first point and said first pivot arm and said rollers may independently rotate about said second point, and said bias member comprises a spring member connecting said first and second pivot arms to thereby bias said rollers towards engagement with said belt.

15. A belt tensioning arrangement in an internal combustion engine, said arrangement comprising:
a crank shaft having a first pulley;
a starter/alternator accessory device having a second pulley;
a belt at least partially wrapped around each said first and second pulleys to establish a driving connection there between; and
a tensioning device having at least two tension members engaging said belt on opposite sides of said second pulley of said starter/alternator along a travel path of said belt, said at least two tension members being movably mounted relative to said internal combustion engine and having a biasing member disposed to bias each of said tension members towards said belt, wherein said starter/alternator has a starting mode and a generating mode inducing a torque to said belt in opposite directions and an idle mode where said second pulley rotates in a substantially free spinning sate, said movably mounted tension members and said biasing member together form a free floating tension assembly to maintain a minimum tension in said belt irrespective of said modes of operation of said starter/alternator to prevent said belt from slipping.

16. The belt tensioning arrangement according to claim 15, wherein said tension members are formed as rollers rotatably connected to at least one pivot arm in turn pivotally mounted in a plane parallel to a plane of rotation of said second pulley.

17. The belt tensioning arrangement according to claim 16, wherein said bias member is a spring member connected to said at least one pivot arm to bias said rollers towards engagement with said belt.

18. The belt tensioning arrangement according to claim 17, wherein said spring member is directly connected to an intermediate portion of said at least one pivot arm.

19. The belt tensioning arrangement according to claim 15, wherein said at least two tension members comprise a pair of rollers one each secured to a corresponding one of a pair of pivot arms movably mounted in a plane parallel to a plane of rotation of said second pulley, said bias member comprising a spring member connecting said pair of pivot arms and in turn biasing said rollers toward engagement with said belt.

20. The belt tensioning arrangement according to claim 19, wherein said spring member is connected to an intermediate portion of one of said pivot arms.

21. The belt tensioning arrangement according to claim 15, wherein said at least two tension members comprise a pair of rollers disposed on opposite ends of a first pivot arm movably mounted in a plane parallel to a plane of rotation of said second pulley, a second pivot arm having a first end pivotally mounted about a first point within said plane of rotation and pivotally secured to said first pivot arm at a second point along an intermediate portion thereof wherein said first pivot arm second pivot arm and said rollers may rotate about said first point and said first pivot arm and said rollers may independently rotate about said second point, and said bias member comprises a spring member connecting said first and second pivot arms to thereby bias said rollers towards engagement with said belt.
